(19) United States
(12) Patent Application Publication
(10) Pub. No.: US 2010/0145754 A1
(43) Pub. Date: Jun. 10, 2010

(54) SYSTEMS, METHODS, APPARATUSES AND COMPUTER PROGRAM PRODUCTS FOR GENERATING CUSTOMIZED RETURN NOTIFICATIONS

(75) Inventor: Atm A. Rahman, Overland Park, KS (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 12/331,002

(22) Filed: Dec. 9, 2008

(51) Int. Cl. G06Q 10/00; G06Q 50/00

(52) U.S. Cl. 705/8; 705/28

(57) ABSTRACT

An apparatus and system are provided for facilitating a customized return process in which notifications may be sent to a customer reminding the customer to return a product. The apparatus includes a processor capable of periodically monitoring tracking information associated with a product(s) and determine whether a product(s) corresponds to a particular type of package. The processor is also capable of determining, at a specified time, whether the product has departed a location of a first entity and determining whether the first entity was given a time frame in which the product(s) was scheduled to depart the location of the first entity and whether the product departed the first location upon the expiration of a time period. The processor is also capable of generating a message that is sent to the first entity instructing the first entity to send the product to another entity within a predetermined time period.

### TECHNOLOGICAL FIELD

Exemplary embodiments of the invention relate generally to systems, methods, apparatuses and computer program products for improving product return processes and more particularly relates to a mechanism of enhancing the visibility of product return processes and generating one or more notifications to inform an entity that a product was not received within a specified amount of time.

### BACKGROUND

Currently, some companies that sell products to customers have mechanisms in place such that a customer could return a purchased product to the company and in return the customer could receive a refund. In some instances, companies allow a customer to return a defective product to them, and upon receipt of the defective product, the company will send the customer another product. For instance, if a defective product is under warranty, many companies today will allow a customer to send them the defective product and upon receipt the company will send the customer another product, i.e., a replacement product, which may be a new or a refurbished product. At this time, it is not uncommon for shipping carriers to handle the delivery of the defective products and replacement products on behalf of companies selling products and the customers of these companies during the product return process.

Oftentimes, if a product is expensive or important to a customer or a customer's business, (e.g., medical equipment of a health institution) a company may allow a customer to initiate the process of returning the defective product and the company may send a replacement unit to the customer while the defective product is in route to the company. In other words, the company may not require receipt of the defective product before sending the replacement product to the customer. By sending the replacement unit to the customer before the company receives the defective product, the amount of time that the customer is without the product is typically minimized which may lessen momentary losses to a customer's business. For instance, if the defective product is a medical device for generating magnetic resonance images (MRIs) to visualize the structure and function of a human body, a customer such as for example a medical clinic would likely want to obtain a replacement unit as soon as possible so that it could minimize the impact of monetary losses associated with being unable to perform MRIs for patients while the defective medical device is being sent to a manufacturer for repair or the like. Sending the replacement unit to the medical clinic prior to the manufacturer receiving the defective medical device will typically lessen the amount of time that the medical clinic is without the product and minimize momentary losses associated with the medical clinic's business.

One drawback of current product return systems consists of a difficulty to adequately monitor and track the location of all products that are to be delivered between entities such as customers and companies during a product return process as well as a difficulty in identifying whether a customer has sent a product(s) for return to a company. Typically, companies require customers to return products (e.g., defective products) to them within a specified time period (e.g., two weeks). During the process of coordinating the return of a product, a company may also require customers to arrange for pickup and delivery of the product to the company within a specified time period. For instance, the company may require the customer to arrange for pickup and delivery of the product within three days from initiating the process of returning the product. In this example, the customer would have three days to arrange for pickup of the product by a shipping carrier, for example, for delivery of the product to the company. However, in existing product return systems, a company is typically not provided an efficient mechanism in which to determine whether the customer has arranged for pickup and delivery of the product within the specified time period (e.g., three days) and it is difficult to determine whether an entity (e.g., shipping carrier) has actually picked up the product for delivery to the company.

Another drawback to existing product return systems arises due to failure of the customer to arrange for pickup and delivery of the product (to be returned to the company) within the required timeframe (e.g., three days). In particular, failure of the customer to arrange for pickup and delivery of the product within the required timeframe often results in monetary losses to the company especially in situations in which the product is expensive. To complicate matters, in some instances, the company may never receive the product(s) to be returned, which may result in additional monetary losses to the company. In this regard, some companies using existing product return systems typically only receive about 60% of the products to be returned by customers. Companies can typically fix a defective product or reuse parts of defective products in replacement units or the like. For instance, a company selling medical equipment may be able save $500 per each returned product by repairing the product or reusing parts of the products. As such, a company may be able to save a huge amount of money by recovering most or all of the products to be returned, especially in situations where there is a significant amount of products designated for return to the company.

Thus a need exists to provide a systematic and efficient approach to improve visibility, monitoring and tracking capabilities of products that are delivered between companies and their customers during a return process, as well as to provide a mechanism in which to proactively identify whether customers have arranged for delivery of products to be returned to a company and a mechanism to notify and remind customers to arrange for delivery of the products to be sent to the company, if the customers have not already arranged for delivery of the products within the required time frame to thereby increase the likelihood that the customer will return the product resulting in additional cost savings to the company.

### BRIEF SUMMARY

One or more exemplary embodiments of the invention provide a mechanism for returning products to an institution, such as for example a company, manufacturer, distributor, supplier, retailer or the like on behalf of a customer. As referred to herein, an institution may be defined as an entity from which a customer purchased a product(s) or an entity which manufactured a product(s) obtained by a customer (e.g., consumer or the like). Additionally, the exemplary embodiments provide a mechanism in which to facilitate sending of one or more new or replacement products to one or more customers while the customers' products are in the process of being sent to the institution. The products returned by the customers to the institution may be defective, damaged, inoperative or the like. The exemplary embodiments may be utilized by the institution to track all of the products that are being sent to customers as new or replacement products as well as the products that customers are to be returned to the institution. For instance, the exemplary embodiments may associate or link a tracking number(s) of a product(s) to be sent to a customer(s) by an institution with a corresponding tracking number(s) of a product(s) that is to be returned to an institution by a customer(s). In this regard, if there is updated information (e.g., a location of the product) associated with a product (e.g., product to be returned to customer) corresponding to one of the tracking numbers, information may also be assessed pertaining to the product (e.g., product to be sent to institution) associated with the other tracking number (e.g., a location of the product).

The exemplary embodiments also enable an institution to determine whether a product scheduled to be returned to the institution has departed a location of the customer for delivery to the institution upon the expiration of a predetermined time. If the product has not departed a location of the customer for delivery to the institution or has not arranged for the delivery of the product to the institution upon the expiration of the predetermined time, the exemplary embodiments are capable of sending the customer a message reminding the customer to send the product to the institution and may instruct the customer to send the product within a new time period. Additionally, the exemplary embodiments may charge the customer a fee for not sending the product to the institution within the originally-scheduled time period for sending the product(s) to the institution and may provide shipping service options to the customer to arrange for delivery of the product(s) to the institution.

In this regard, the exemplary embodiments may provide mechanisms in which to recover products to be returned from a customer faster than existing approaches and may result in an increase in the percentage of returned products received by a company, resulting in potential savings due to the recovery of each additional product received from a customer(s).

In one exemplary embodiment, a corresponding method and computer program product for facilitating a customized return process are provided. The method and computer program product may include periodically monitoring tracking information associated with one or more products and determining whether a product(s) corresponds to a first type of product. The method and computer program product also may included determining, at a first specified time, whether the a product(s) has departed a first location of a first entity in route for delivery to a second entity, in response to determining that the product(s) corresponds to a first type. Additionally, the method and computer program product also includes determining whether the first entity was given a first predetermined time period in which the product(s) was scheduled to depart the first location of the first entity in route for delivery to the second entity. In response to a determination revealing that the first entity was given the first predetermined time period, determining whether the product(s) departed the first location of the first entity upon expiration of the predetermined time period. The method and computer program product may also include sending a first message to the first entity in response to a determination revealing that a product(s) did not depart from the first location upon the expiration of the predetermined time period. The first message may include data instructing the first entity to send the product to the second entity within a second predetermined time period.

In yet another exemplary embodiment, an apparatus for facilitating a customized return process is provided. The apparatus may include a processor configured to periodically monitor tracking information associated with a product(s) and determine whether a product(s) corresponds to a first type of product among a plurality of types of products. In response to determining that a product(s) corresponds to a first type of product, the processor is also capable of determining, at a first specified time, whether a product(s) has departed a first location of a first entity in route for delivery to a second entity and determining whether the first entity was given a first predetermined time period in which the product(s) was scheduled to depart the first location of the first entity in route for delivery to the second entity. In response to a determination revealing that the first entity was given the first predetermined time period, the processor is also capable of determining whether the product(s) departed the first location of the first entity upon expiration of the predetermined time period. Additionally, the processor is capable of sending a first message to a first device which is configured to transmit the first message to the first entity in response to a determination revealing that the product(s) did not depart from the first location upon the expiration of the predetermined time period. The first message includes data instructing the first entity to send the product to the second entity within a second predetermined time period.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of an electronic device according to an exemplary embodiment of the invention;

FIG. 2 is a schematic block diagram of a system for providing customized returns with notifications according to an exemplary embodiment of the invention;

FIG. 3 is a schematic block diagram of a system according to an exemplary embodiment of the invention; and

FIGS. 4A & 4B illustrate a flowchart for facilitating a customized return process according to an exemplary embodiment of the invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

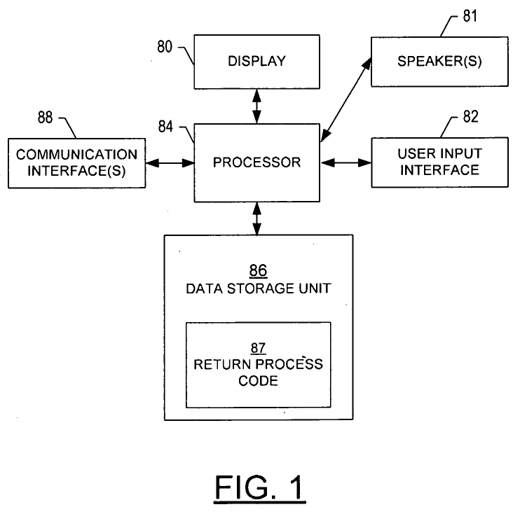

FIG. 1 illustrates a block diagram of an electronic device such as a client, server, computing device (e.g., personal computer (PC), computer workstation, laptop computer, personal digital assistant, fixed or mobile phone, etc.) or the like that would benefit from embodiments of the invention. The electronic device includes various elements or apparatuses for performing one or more functions in accordance with exemplary embodiments of the invention, including those more particularly shown and described herein. It should be understood, however, that the electronic device(s) of the exemplary embodiments may include alternative elements or apparatuses for performing one or more like functions, without departing from the spirit and scope of the invention. More particularly, for example, as shown in FIG. 1, the electronic device can include a processor 84 connected to a data storage unit 86. The data storage unit can comprise volatile and/or non-volatile memory, and typically stores content, data, information or the like. For example, the data storage unit may store content transmitted from, or received by, the electronic device. The data storage unit 86 is capable of storing data, including but not limited to, information related to pickup or delivery of goods, products or packages, etc. as well as information associated with the return of a product purchased from an organization or institution, including but not limited to a company, manufacturer, supplier, corporation, partnership, association or the like. As described above, an institution may be referred to herein to denote an entity from which a customer purchased a product(s) or an entity which manufactured a product(s) obtained by a customer (e.g., consumer or the like). As referred to herein a customer may be a purchaser and/or user of one or more products and a customer may be either an individual or organization.

It should be pointed out that the returned product(s) may but need not be a defective product, a damaged product or any other suitable product. Additionally, the data storage unit 86 may store data associated with sending a customer a replacement unit to temporarily or permanently replace the returned product. The data storage unit 86 may also store data associated with defined time triggers which may be periods of time (e.g., two days) defined to trigger the generation of a notification message that is sent to a customer. The notification message may contain information reminding the customer that a defined time period in which a product was originally scheduled to depart from, or be shipped from, the customer and be delivered to a facility of an institution, has elapsed or expired and the information may instruct the customer to proceed with the process of arranging to deliver or send the product to the facility of the institution.

Moreover, the notification message may contain information indicating that the product should be sent within a specified amount of time and may include information specifying a late fee for not sending the product within the original scheduled time period for departure. The information in the notification message may include, but is not limited to voice data, text data, multimedia data or any other suitable data. The notification message may also contain data requesting the customer to indicate whether it would like the institution to arrange for delivery of the product(s) on behalf of the customer. In this regard, the institution may arrange for a shipping carrier to pickup the product(s) within a specified amount of time for delivery to a facility (e.g., return center) of the institution. The institution may, but need not charge the customer a fee for arranging delivery of the product(s) and may also charge the customer a fee associated with the shipping services.

Also for example, the data storage unit 86 typically stores client applications, instructions or the like for executing the processor 84 to perform steps associated with operation of the electronic device in accordance with embodiments of the present invention. As explained below, for example, the data storage unit can store one or more client application(s) such as for example software or algorithms that may be executed by a processor. For instance, the data storage unit 86 may store a return process code 87 which may be executed by the processor 84.

The software or algorithms, such as for example return process code 87, that may be executed by the processor may be associated with determining whether one or more defined time periods associated with the return of one or more products has elapsed or expired and in response to the defined time period elapsing or expiring, automatically triggering the generation of a notification message to be sent to a customer instructing the customer to arrange for pickup and delivery of the product(s) within a specified amount of time (e.g., two days). For instance the notification message may include information indicating that the customer has two days to arrange for arrange for delivery of the product to the institution and by a specified time (e.g., 10:00 AM) on the second day, the product must depart the customer and be shipped to a facility of the institution to above late fees.

The processor may also be capable of executing software or algorithms (e.g., return process code 87) stored in memory that calculate one or more payments that is owed to the institution as a result of arranging shipment of the products on behalf of the customer, accessing late fees for failure to ship an item within an specified time period or any other suitable fees. The processor may also execute software or algorithms (e.g., return process code 87) stored in memory that calculate one or more payments that is owed to a shipping carrier associated with shipping services for pickup and/or delivery of one or more products.

The electronic device can include one or more logic elements for performing various functions as it executes one or more client application(s). The logic elements performing the functions can be embodied in an integrated circuit assembly including one or more integrated circuits integral or otherwise in communication with a respective network entity (i.e., computing system, client, server, etc.) or more particularly, for example, a processor 84 of the respective network entity.

In addition to the data storage unit 86, the processor 84 can also be connected to at least one interface or other device that displays, transmits, or receives data, content or the like. The interface(s) can include at least one communication interface 88 or other elements for transmitting and/or receiving signals, data, content or the like. In this regard, the communication interface 88 may include, for example, an antenna and supporting hardware and/or software for enabling communications with a wireless communication network. For example, the communication interface(s) can include a first communication interface for connecting to a first network, and a second communication interface for connecting to a second network. In this regard, the electronic device is capable of communicating with other electronic devices over a network such as a Local Area Network (LAN), Wide Area Network (WAN), Wireless Wide Area Network (WWAN), the Internet, or the like. Alternatively, the communication interface can support a wired connection with the respective network. The signals that the communication interface 88 may receive and/or transmit may include information consisting of speech (e.g., voice data) and/or user generated data in accordance with an air standard interface standard of a cellular system, for example. In this regard, the electronic device may operate in accordance with one or more wireless communication protocols. In an alternative exemplary embodiment, the electronic device may operate in accordance with non-cellular communication mechanisms such as for example landline signals received from a Public Switched Telephone Network (PSTN).

In addition to the communication interface(s), the interface(s) can also include at least one user interface that can include one or more earphones or speakers 81, a display 80, or a user input interface 82. The user input interface, in turn, can comprise any of a number of devices allowing the entity to receive data from a user, such as a microphone, a keypad, keyboard, a touch display, a joystick, image capture device, pointing device (e.g., mouse), stylus or other input device.

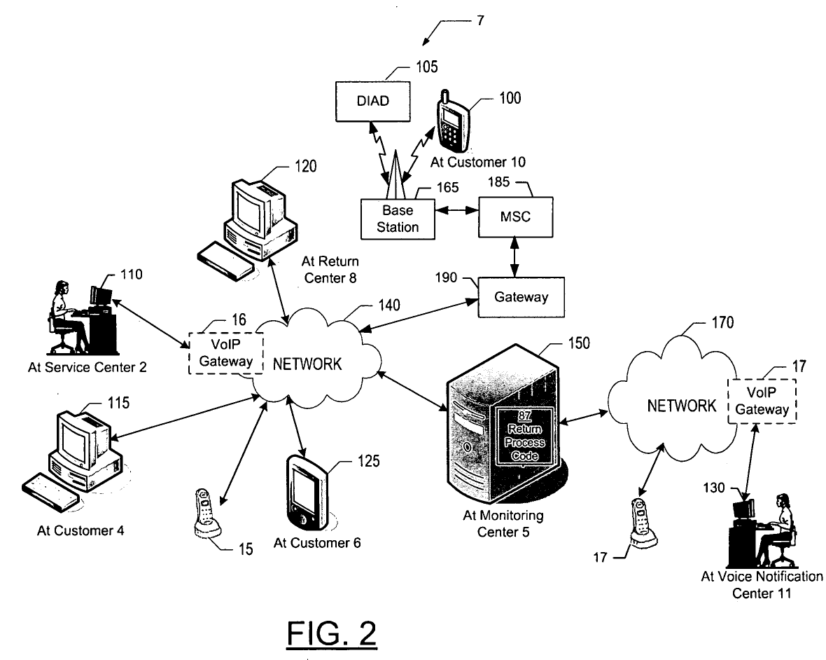

Reference is now made to FIG. 2, which is a block diagram of an overall system that would benefit from exemplary embodiments of the invention. It should be pointed out that the Voice over Internet Protocol (VoIP) telephones 16 and 17, mobile or fixed phone 100, delivery information acquisition device (DIAD) 105, electronic devices 110, 115, 120, 125 and 130 (e.g., personal computers, laptops, personal digital assistants and the like) and server 150 of the system of FIG. 2 may comprise the elements of the electronic device illustrated in FIG. 1. It should be pointed out that the server 150 may store the return process code 87 in its memory (e.g., data storage unit 86) and the processor (e.g., processor 84) of the server 150 may execute the return process code.

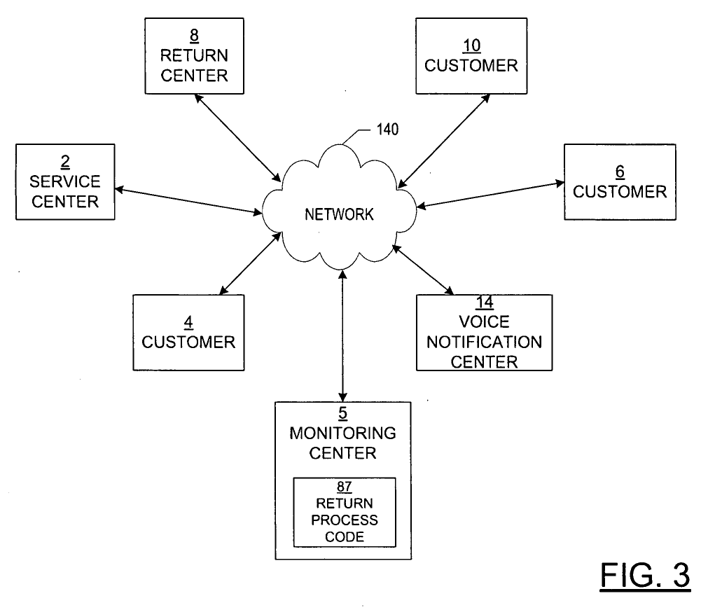

In the system 7 of FIG. 2, the mobile or fixed phone 100, as well as electronic devices 115 and 125 may, but need not, be maintained and operated by one or more customers (e.g., customers 4, 6, 10 and 12). The electronic device 110 may, but need not, be operated and maintained on behalf of a service center 2 and electronic device 120 may, but need not, be operated and maintained on behalf of a return center 8. Additionally, electronic device 130 may, but need not, be operated and maintained on behalf of a voice notification center 11 and the server 150 may, but need not, be operated and maintained on behalf of an entity, such as for example a monitoring center 5, capable of tracking and monitoring activity within the system 7. (See e.g., FIG. 3) In an exemplary embodiment, the entity that is capable of tracking and monitoring activity within the system 7 may be a carrier, such as for example a shipping carrier. In other words, the monitoring center 5 may be maintained and operated by a shipping carrier. It should be pointed out that the VoIP telephone 15 and VoIP telephone 17 may be utilized by any suitable entity (e.g., customers). In like manner, the DIAD 105 may be utilized by any suitable entity (e.g., staff personnel of a shipping carrier).

Each of the electronic devices 110, 115, 120 and 125 may access a server 150, or similar network entity, over a network 140, such as a wired or wireless local area network (LAN), a metropolitan network (MAN) or a wide area network (WAN) (e.g., the Internet). Similarly, electronic device 130 may access the server 150, or similar network entity over a network 170, such as a wired or wireless local area network (LAN), a metropolitan network (MAN) and/or a wide area network (WAN) (e.g., the Internet). In an exemplary alternative embodiment the network 140 may be the Internet. Although five electronic devices 110, 115, 120, 125 and 130 are shown in FIG. 2, it should be pointed out that any suitable number of electronic devices may be part of the system of FIG. 2.

The electronic devices 110 and 130 are also capable of receiving and/or transmitting voice data (e.g., speech data) that may be associated with telephone calls for example. Additionally, the electronic devices 110 and 130 are also capable of receiving and/or transmitting text data, video data, multimedia data and any other suitable data. The voice data may, but need not, be VoIP data consisting of data packets that can be transmitted over a packet switching network (e.g., networks 140 and 170) such as the Internet. In this regard, the VoIP data may be sent to any one of electronic devices 110 and 130 from a VoIP telephone (e.g., VoIP telephone 15 or VoIP telephone 17) which may send voice data in the form of data packets. The electronic device 110 or electronic device 130 may send data packets to networks 140 and 170 via VoIP gateways 16 and 17. Alternatively, the voice data may, but need not, include circuit-switched data signals, received from a circuit-switched network (e.g., PSTN). For instance, if a caller calls any one of electronic devices 110 and 130 and the call is routed to either electronic device 110 or electronic device 130 via a PSTN, the voice data associated with the call may include circuit-switched data signals, since the PSTN is a circuit-switched network. In this regard, the electronic devices 110 and 130 may send the voice data to VoIP gateway 16 and 17, respectively. VoIP gateway 16 and VoIP gateway 17 may be any device or means embodied in hardware and/or software capable of converting circuit-switched data signals to data packets that may be used by networks 140 and 170. In this regard, the VoIP gateways 16 and 17 may operate as a pass through switch for VoIP data, including but not limited to packetized speech data, text data, video data, multimedia data and the like.

As mentioned above, the system 7 may include a mobile or fixed phone 100 and a scanning a tracking device such as for example a DIAD 105. The DIAD 105 and the mobile or fixed phone 100 may each include an antenna (not shown) for transmitting signals to a base station 165 or receiving signals from a base station 165 is shown in FIG. 2. The DIAD 105 may be a mobile device and may be moved throughout the system 7. The base station 165 may consist of a cellular network, which includes elements required to operate the network, such as, for example, a mobile switching center (MSC) 185. The MSC 185 is capable of routing information to and from the mobile or fixed phone 100 and the DIAD 105. The MSC 185 can be coupled to a gateway 190, and the gateway 190 may be coupled to a network 140 (e.g., Internet). As such, the electronic devices 110, 115, 120, 125, and 130 as well as the server 150 and VoIP telephones 15 and 17 can be coupled to the mobile or fixed phone 100 as well as the DIAD 105 via the networks 140 and 170. The DIAD 105 may include a scanning device executed by a processor, controller or the like that is capable of scanning information such as one or more codes, labels, (e.g., bar code labels) tracking numbers or the like. The information obtained by scanning may be transmitted to the server 150 which may store this information in its data storage unit 86 and which may upload this information to a web site. In an exemplary embodiment, the DIAD 105 may scan shipping labels or tracking numbers on various products. These products include but are not limited to defective devices or units, as well as replacement devices or units and the scanned information may be provided by the DIAD to the server 150, which may, but need not, upload the information to a web site. It should be pointed out that although only one mobile or fixed phone 100, DIAD 105, base station 165, MSC 185 and gateway 190 is shown in FIG. 2 any suitable number of mobile or fixed phones 100, DIADs 105, base stations 165, MSCs 185 and gateways 190 may be within the system 7 without departing from the spirit and scope of the invention.

Referring now to FIG. 3, a system in which devices of FIG. 2 that are maintained and operated by entities such as service center 2, customer 4, monitoring center 5, customer 6, return center 8, customer 10, and voice notification center 11 may be coupled to each other either directly via network 140 (or indirectly by network 140 via network 170). The monitoring center 5 may contain a device (e.g., the processor of server 150) that executes the return process code 87. The service center 2 may be maintained by an institution from which a customer purchased a product(s) or which manufactured a product(s) obtained by a customer. In an exemplary embodiment, a customer (e.g., customer 10) may utilize a device such as for example, mobile or fixed phone 100 to contact the service center 2 to report that a product(s) should be returned to the institution (e.g., company) that maintains the service center 2. In this regard, the product(s) may be defective or damaged or is otherwise unfit for its intended use. It should be pointed out that the customer may utilize the mobile phone 100 to contact the service center 2 by placing a telephone call to a representative of the service system or an automated telephone system maintained by the telephone system. Alternatively, the customer may utilize a VoIP telephone (VoIP telephone 15 or 17) to contact the service center 2. In addition, the customer may utilize the mobile or fixed phone to access a web site of the service provider 2 that is maintained and operated by electronic device 110. The web site may contain information allowing one or more customers to initiate a process for returning a product(s) or device(s). Electronic device 115 and 125 may also be utilized by a customer to access the web site of the service center 2 and initiate the process of returning a product.

The service center may obtain information from the customer to determine if the product qualifies to be returned. For instance, the service center may request that the customer provide the service center with the serial number associated with the product, or a Universal Product Code (UPC) code, or any other suitable information, to determine if the product is still under warranty and is qualified for return. If the processor of the electronic device 110 that is maintained by the service center 2 determines that the product qualifies for return, the service center may initiate a return process and may generate one or more orders for the return of the product. In an alternative exemplary embodiment, a representative of the service center 2 may determine that the product(s) qualifies for return. In response to the processor of electronic device 115, maintained by the service center 2, determining that one or more products qualify for a return, the processor of the electronic device 115 may generate one or more orders for the return of the product and may send a device (e.g., mobile or fixed phone 100) of the customer a message (e.g., electronic mail (email), short message service message (SMS) Multimedia Messaging Service message (MMS) or the like) indicating that an order is being processed for the return of the product to the service center. The message that is sent from the electronic device 115 to the device (e.g., mobile or fixed phone) of the customer may contain instructions specifying the manner in which the product(s) is to be returned to the institution that maintains the service center. Additionally, the processor of the electronic device 110 may arrange for a new or replacement product to be sent to the customer. In this regard, the processor of the electronic device may send a device, such as for example mobile or fixed phone 100, of the customer a message notifying the customer that a new or replacement product has been sent to the customer or is in route to the customer.

As mentioned above, in response to the processor of electronic device 110 maintained by the service center 2 determining that one or more products qualify for a return, the processor of the electronic device 110 may generate one or more orders (also referred to herein as order files) for the return of the product. These orders may be generated on a daily basis and may be stored in a data storage unit of the electronic device 1 10. In an alternative embodiment, the orders may be generated during any other suitable time for example hourly, every other day, weekly, etc. The orders may contain information specifying an order number(s) (e.g., a reference number used by the institution maintaining the service center 2 to identify a particular order), a return merchandise authorization (RMA) number (e.g., a number used to refer to a customer arranging to return a defective or damaged good(s) to an institution (e.g., supplier) in order to have the product repaired or replaced or in order to receive a refund or credit for another product from the institution), an institution identifier (e.g., a numeric code indentifying the institution maintaining the service center), a customer identifier(s) (ID) (e.g., a customer number that identifies a customer of the service center, a customer number identifying the service center), telephone number(s) (e.g., telephone number of the customer or consignee), a location identifier(s) (e.g., the name of a city and state, a zip code, city code, city abbreviation, (e.g., ATL for Atlanta, Ga.) in which the product to be returned by the customer is located, etc.), information identifying products for delivery or receipt or any other suitable information that is associated with one or more products to be returned to an institution or one more new or replacement products to be sent to a customer. For instance, the orders may also contain information specifying whether a customer(s) is given a time frame or time period (e.g., 48 hrs., 72 hrs., etc.) in which to arrange for delivery of a product or package to a facility of an institution. For instance, in an alternative exemplary embodiment, the orders may also contain one or more account number(s), and one or more address as well as email addresses associated with one or more customers or consignees. It should be pointed out that the information contained in the orders may be referred herein as manifest data.

The processor of the electronic device 110 may send these orders to the electronic device 120 of the return center 8, which may store the orders in a data storage unit (e.g., data storage unit 86) of the electronic device 110. Additionally, the service center 2 may send new or replacement products, associated with the return of a product by a customer(s), to the return center 8. Moreover, the products to be returned to the service center 2 by the customer may be sent by the customer to the return center 8 and the return center 8 may arrange for the delivery of the products to the service center 2. The service center and customer(s) may utilize a shipping carrier to deliver product(s) to be returned as well as the new or replacement products to the return center. The products (e.g., new or replacement packages) that are scheduled to be sent to the return center 8 for delivery to a customer may be referred to herein as outbound packages (also referred to herein as outbound products). On the other hand, the products that are scheduled to be received by the return center 8 which are to be delivered to the service center 2 may be referred to herein as inbound packages (also referred to herein as inbound products).

It should be pointed out that the processor (e.g., processor 84) of the electronic device 120 may access one or more of the orders or order files stored in the data storage unit and generate tracking numbers and shipping labels for both inbound packages and outbound packages. For instance, in response to an order(s) containing information indicating that a product is to be returned to the institution by the customer (i.e., inbound product) and also contains information indicating that the institution is to send the customer a new or replacement product (i.e., outbound product), the processor of the electronic device 120 may generate a tracking number for the inbound product and a tracking number for the outbound product and the processor of the electronic device 120 may associate these tracking numbers with each other. In this regard, the tracking numbers may be linked to each other based on an alphanumeric code or any other suitable mechanisms.

In an exemplary embodiment, the processor of the electronic device 120 may generate an alphanumeric code that links the tracking numbers of outbound and inbound products and this alphanumeric code may be associated with a customer number of the customer returning the product and an identifier of the institution sending the customer a replacement product. For example, the customer number may be 1ZE083 and the institution identifier may be R001. As such, the processor of the electronic device 120 is capable of using the institution number and the customer number to generate a tracking number for the inbound product such as for example 1ZE083R00149127452 and a tracking number for the outbound product such as for example 1ZE083R00151739279. In this manner, the processor of the electronic device 120 may link the tracking numbers of the inbound and outbound products to each other by using the numeric code corresponding to the institution number and the customer number (e.g., 1ZE083R001). The tracking numbers generated by the processor of the electronic device may be stored in the data storage unit of the electronic device 120. It should be pointed out that while 1ZE083 was used as the customer number and R001 was used as the institution number in the above example that any other suitable customer numbers and institution numbers may be used without departing from the spirit and scope of the invention. Additionally, tracking numbers other than 1ZE083R00149127452 and 1ZE083R00151739279 may also be generated by the processor of the electronic device 120. The processor of the electronic device 120 may send the tracking numbers to server 150.

In an alternative exemplary embodiment, the processor of the electronic device 120 may use an order number or an account number associated with a corresponding order file to generate the tracking numbers for the inbound and outbound products. For instance, an order number (or alternatively an account number for example) such as for example 1DE083R02 may be associated with an order corresponding to both the institution responsible for sending the customer a new or replacement product and the customer responsible for sending a product to be returned to the institution. In this regard, the processor of the electronic device 120 is capable of using the order number to generate a tracking number such as for example 1DE083R02893311057 for the inbound product and a tracking number such as 1DE083R02890827069 for the outbound product. Additionally, the processor of the electronic device 120 is capable of linking or associating the tracking numbers of the inbound and outbound products (e.g., 1DE083R02893311057 and 1DE083R02890827069) with each other and may store them in a data storage unit of the electronic device.

The processor of the electronic device is also capable of generating one or more shipping labels that may be attached to the products or packaging of the products. These shipping labels may contain information indicating the tracking numbers generated by the processor of the electronic device 120. Additionally, the shipping labels may indicate a service level associated with the products or packages. For example, in an exemplary embodiment, outbound products or packages may have a Next Day Air delivery service level, whereas the inbound products or packages may have a 3 Day Ground or 2nd Day Air delivery service level. However, it should be pointed out that the outbound and inbound products and packages may be associated with any other suitable service levels. Additionally, the inbound products or packages may have a return service request containing information specifying that the product is to be returned to the customer within a certain time frame (e.g., within two weeks of receipt).

The tracking numbers may be scanned by a scanning device such as for example DIAD 105 and information obtained from scanning may be transmitted to the server 150 which may store this information in its memory (e.g., data storage unit) and which may upload this information to a web site in a manner analogous to that discussed above. For instance, the information obtained from scanning may indicate a location of a product(s) or package(s) in route to a destination and may indicate an expected arrival time at a subsequent location in route to the destination. In addition to the processor of the electronic device 120 sending the information associated with the tracking numbers to the server 150, the processor of the electronic device 120 may also send one or more order files and accompanying manifest data to the server 150, which may also store this information in its data storage unit.

Additionally, since at least some of the tracking numbers may be linked or associated with each other, in response to at least one of the linked tracking numbers (e.g., 1ZE083R00149127452) being accessed, information associated with the other tracking number (e.g., 1DE083R02890827069) may also be available and provided via the web site. In this manner, an entity such as for example, the institution maintaining the service center 2 may receive information indicating the status of the product to be returned by the customer. Similarly, an entity such as, for example, the customer may receive information indicating the status of new or replacement product being sent to the customer by the institution (e.g., a company). Each time a tracking number is scanned (e.g., a tracking number associated with an outbound product), by a scanning device, (e.g., DIAD 105) and the tracking number is linked to or associated with another tracking number (e.g., a tracking number associated with an inbound product), the processor 84 of the server 150 may retrieve information, from its data storage unit, associated with the other tracking number (i.e., associated with the inbound product) to determine the status of the associated product. For instance, in the above example, if there is more current information relating to the inbound product(s) than is presently available via the web site, the processor of the server 150 may upload this information to the web site so that it may be accessible. Similarly, in response to the processor of the server 150 receiving updated information associated with a scan of a tracking number associated with a product such as for example an inbound product, the processor of the server 150 is capable of evaluating the data storage unit to determine if there is more current information, relating to an associated or linked tracking number of an outbound product(s), than is presently available via the web site, and if there is more current information available, the processor of the server 150 may upload this information to the web site so that it may be accessible. In other words, each time updated information associated with one tracking number (of a pair of associated tracking numbers) is received by the processor of the server 150 based on a scan, the processor of the server determines whether there is any updated information available that is associated with the linked tracking number.

It should be pointed out that in some situations the institution may give the customer a certain amount of time (e.g., 24 hrs, 48 hrs, 72 hrs., etc.) before requiring a product to be returned to a facility (e.g., service center) of the institution by the customer. During this time, there may not be any information available relating to the product to be returned (i.e., the inbound product) since the customer may not have arranged to send the product to the institution. As such, there would not be any information associated with a scan of a tracking number associated with the product to be returned in this situation.

As described above, the processor of the server 150 may monitor the activity of the outbound and inbound products or packages based on information stored in its data storage unit in response to receipt of information associated with scanning of the tracking numbers related to the outbound and inbound products or packages. As indicated above, the scanning may be performed by a scanning device such as for example DIAD 105. In this regard, the processor of the server may monitor and analyze the data storage unit for updated activity relating to the outbound and inbound packages or products periodically based on one or more predetermined time triggers, which may also be stored in the data storage unit of the server 150. For instance, the time triggers may be defined such that the processor of the server 150 may analyze and monitor its data storage unit for receipt of information associated with the inbound and outbound products or packages every minute, every half-hour, every hour or based on any other suitable periodic time(s). The processor of the server may determine whether information corresponds to an outbound product or package or an inbound product or package. In this regard, the processor may analyze the tracking number to determine if the product or package is an inbound or outbound product or package. Additionally, the processor of the server 150 may analyze the information to determine a service level associated with the product or package. In an exemplary embodiment, the service level may be linked to each tracking number and as such, the processor of the server 150 may analyze information associated with a tracking number to determine a service level associated with a product or package. For instance, based on the information received from a scanning device (e.g., DIAD 105) the processor of the server 150 may determine that the information relates to an inbound product or package and that this product or package has a return service level.

In an exemplary embodiment, the processor of the server 150 may monitor information associated with outbound packages first and then monitor information associated with inbound packages. The purpose of monitoring information associated with the outbound packages first is to determine if the institution has begun the process of shipping the new or replacement unit to the customer so that the customer will have a replacement product as soon a possible. However, it should be pointed out that the information associated with inbound packages may be monitored first or the information associated with the inbound and outbound packages may be in any suitable order. For instance, the processor of the server may monitor the information based on the order in which it was received by a scanning device or the like (e.g., DIAD 105).

As described above, the processor of the electronic device 120 may send manifest data to the server 150 and this manifest data may be stored in the data storage unit of the server 150. In addition to the information discussed above, the manifest data may also consist of information indicating a time (e.g., 12:00 AM) that one or more inbound or outbound products or packages are scheduled to depart from the return center 8. The processor of the server 150 may determine whether the information, associated with product(s) corresponds to an outbound product(s) or package(s) or an inbound product(s) or package(s). In response to the processor of the server 150 determining that the information associated with the product relates to an outbound product(s) or package(s), the processor of the server 150 may determine whether it received any information from the processor of the electronic device 120 indicating that the product(s) or package(s) departed the return center at the specified time, or within a predetermined threshold of the specified time (±5 min.). In this regard, the processor of the server 150 may send a message to the electronic device 120 of the return center 8 at the indicated time (e.g., 12:00 AM), or within a predetermined threshold or the specified time (±10 min.), requesting information indicating whether a respective outbound product(s) or package(s) departed the return center in route to a destination address at the specified time (e.g., 12:00 AM). In response to receipt of a message from the processor of the electronic device 120 indicating that the respective product or package did not depart from the return center 8, the processor of the server 150 may initiate an escalation process and generate a message that is sent to the processor of the electronic device 120 instructing the personnel of the return center to immediately arrange for sending the outbound product(s) or package(s) to another location in its delivery route.

On the other hand, if the processor of the server 150 receives information from the processor of the electronic device 120 indicating that the product(s) or package(s) did in fact depart from the return center 8 at the specified time, or within a predetermined threshold of the specified time, the processor of the server 150 may automatically validate the manifest data associated with the outbound product(s) or package(s) at a predetermined time, such as for example 4:00 AM each day of a year. While the processor of the server automatically began the process of validating the manifest data at 4:00 AM, in above-mentioned exemplary embodiment, it should be pointed out that any other suitable time may be chosen to begin the process of automatically validating the manifested data without departing from the spirit and scope of the invention.

The processor of the server 150 may validate the manifest data by checking the accuracy of the manifest data. For instance, the processor of the server 150 may verify that an order number contains the appropriate number of digits (e.g., 5 digits), that the customer identifier is provided in the manifest data, that a telephone number of the customer is provided and contains the appropriate number of digits, that an address of the customer is provided and is correct, that a return merchandise authorization (RMA) number contains the appropriate number of digits or alternatively that an email address corresponding to the customer is provided in the manifest, and/or that an institution identifier is contained in the manifest data, etc. If the processor of the server 150 determines that any of the manifest data is incorrect, the processor of the server 150 may send the electronic device 120 a message requesting updated correct manifest data which the processor of the electronic device 120 may retrieve from the data storage unit of the electronic device 120 or may alternatively retrieve from a data storage unit of the electronic device 110 and may send the correct manifest data to the server 150 for storage in the data storage unit of the server 150.

Once the processor of the server 150 determines that the validated manifest data is correct, the processor of the server 150 may input additional information in the validated manifest data, for example information indicating an expected delivery time (e.g., 10:30 AM) and date (e.g., December 21st of a given year) of a product or package to a location of a customer or any other suitable information. The processor of the server 150 may then immediately send the data associated with the validated manifest data, which includes the delivery time information, to the electronic device 130 of the voice notification center 11 where it may be stored in a data storage unit of the electronic device 130. The validated manifest data may, but need not, be sent by the processor of the server 150 to the electronic device 130 in a file, folder or the like. Alternatively, the processor of the server 150 may send the raw data, associated with the manifest data to the electronic device 130 without regards to placing the validated manifest data in a file, folder or the like. The processor (e.g., processor 84) of the electronic device 130 may retrieve the validated manifest data and may generate a message(s) that may be sent by the processor of the electronic device 130 to a device (e.g., mobile or fixed phone 100) of the customer. This message(s) may, but need not, be a voice message containing speech data. For instance, the processor of the electronic device 130 may call a telephone number of a device (e.g., mobile or fixed phone 100) of the customer and play the speech data associated with the message(s) in response to the device of the customer answering the telephone call. The speech data in the voice message that may be received by the device (e.g., mobile or fixed phone 100) of the customer may notify the customer of an expected delivery time (e.g., 10:30 AM) and date (e.g., December 21st of a given year) of a product or package and may also inform the customer of the location in which the product or package will be delivered.

It should be pointed out that the speech data of the voice message may contain any other suitable data. The processor of the electronic device 130 may, but need not send the message(s) to the device of the customer by using a File Transfer Protocol (FTP). However, it should be pointed out that the processor of the electronic device 130 may send the message(s) to the device (e.g., mobile or fixed phone 100, VoIP telephone 15 or VoIP telephone 17) of the customer using any other suitable protocols or other suitable mechanisms of handling any type of file transfers. Additionally, the speech data of the messages sent from the electronic device 130 of the voice notification center 11 to a device of the customer may, but need not, consist of VoIP data signals. Although the message(s) above sent from the electronic device 130 to a device (e.g., mobile or fixed phone 100) of the customer was described to include speech data associated with a telephone call it should be pointed out that the processor of the electronic device 130 may send the information associated with the message(s) to the device of the customer in any other suitable manner such as for example, in the form of a text message or SMS message, an email message, a MMS message or any other suitable message.

As discussed above, the processor of the server 150 may also monitor information associated with one or more inbound products or packages. For instance, as explained above, the processor of the server 150 may monitor the activity of the inbound product(s) or package(s) based on information stored in its data storage unit in response to receipt of information associated with scanning of the tracking numbers related to the inbound product(s) or package(s). Some of these inbound products or packages may be associated with a return service level. In this regard, the inbound products or packages that may be received by a facility (e.g., service center 2) of the institution may be scheduled to be returned to a customer by the institution after an amount of time. For instance, the inbound product may be returned to the customer by the institution after a time (e.g., 2 weeks) that is sufficient to repair the product(s).

At a predetermined time (e.g., 4:30 AM each day of a year), the processor of the server 150 may analyze and monitor its data storage unit to determine if information associated with scanning a tracking number of an inbound package(s) or product(s) has been received by a scanning device such as for example DIAD 105. If the processor of the server 150 determines that there is no information available for an inbound product(s) or package(s) as a result of a scan, the processor of the server 150 may determine that the customer has not yet arranged for delivery of the inbound product or package to a facility (e.g., service center 2) of the institution. Additionally, the processor of the server 150 may examine the information in the manifest data to determine whether the customer was given a time frame or time period (e.g., 48 hrs., 72 hrs., etc.) in which to arrange for delivery of the inbound product or package to a facility (e.g., service center 2) of the institution. If the processor determines that there was a time frame in which the customer is allowed to arrange for the product (i.e., an inbound product) to depart a location of the customer in route for delivery to the institution, the processor of the server 150 may determine whether that time frame has passed. If the time frame has not yet passed or elapsed, the processor of the server 150 may monitor the status of the inbound product or package by examining its data storage unit upon expiration of the time period. On the other hand, if the processor of the server 150 determines that the time frame has already passed or elapsed, the processor of the server 150 may validate the manifest data in a manner analogous to that described above and the processor of the server 150 may include information in the validated manifest data and the validated manifest data may be sent to the electronic device 130 of the voice notification center 11. The information in the validated data may instruct the processor of the electronic device 130 to send a message to a device (e.g., mobile or fixed phone 100, VoIP telephone 15 or VoIP telephone 17) of the customer instructing the customer to arrange for delivery of the product(s) to be returned to a facility (e.g., service center 2) of the institution.

In this regard, the processor of the electronic device 130 may generate a message that may be sent to a device (e.g., mobile or fixed phone 100) of the customer reminding the customer that the product has not yet departed a location of the customer in route to the institution and instructing the customer to arrange for delivery of the product to the institution within a specified time frame (e.g., 24 hrs., 48 hrs., etc). The message sent to the device of the customer from the processor of the electronic device 130 may, but need not, also include data associated with a late fee that the customer owes the institution for not arranging for the product(s) to be picked up for delivery within the originally-specified time frame.

The message that is sent to the device of the customer from the processor of the electronic device 130 of the voice notification center 11 may consist of voice data including one or more speech data or signals and the message may be conveyed via a telephone call to the device of the customer. In this regard, the processor of the electronic device 130 may access the customer's telephone number in the validated manifest data to call the device of the customer. In addition to the message conveyed by the telephone call to the device of the customer reminding the customer that the product has not yet departed a location of the customer in route to the institution and instructing the customer to arrange for delivery of the product to the institution within a specified time frame as well as optionally including voice data indicating that a late fee is owed to the institution by the customer, the voice data may also include speech data (e.g., an automated recording) asking the customer if the customer would like the voice notification center 11 to arrange for pickup of the product(s) to be returned to a facility (e.g., service center 2) of the institution. In this regard, the speech data may prompt the customer to press an alphanumeric character (e.g., “1”) on a keypad of the device if the customer wants the voice notification center 11 to arrange for delivery of the product(s) to a facility of the institution. If the customer presses the alphanumeric character, the processor of other electronic device 130 may send speech data to the device of the customer asking the customer what time and date should the product(s) be picked up and what location should the product(s) be picked up from for delivery to the institution. Additionally, if the customer presses another alphanumeric character (e.g., “0”) on a keypad of the device, the processor of the electronic device 130 may transfer the telephone call to a human representative of the voice notification center 11. In this regard, the customer or a representative of the customer may speak directly with the representative of the voice notification center 11 to address any other issues and concerns that the customer may have.

Although it was described in the example above that the message that is sent to the device of the customer from the processor of the electronic device 130 of the voice notification center 11 may consist of voice data including one or more speech data or signals and that the message may be conveyed via a telephone call to the device of the customer, it should be pointed out that the message may be conveyed by the processor of the electronic device 130 to a device of the customer according to any other suitable mechanism. In this regard, the message may include data signals and may be sent, to the device of the customer by the processor of the electronic device 130, in the form of a text message, email message, SMS message, MMS message or any other suitable message. The processor of the electronic device 130 may, but need not send the message(s) to the device of the customer by using a FTP. However, it should be pointed out that the processor of the electronic device 130 may send the message(s) to the device (e.g., mobile or fixed phone 100, VoIP telephone 15 or VoIP telephone 17) of the customer using any other suitable protocols.

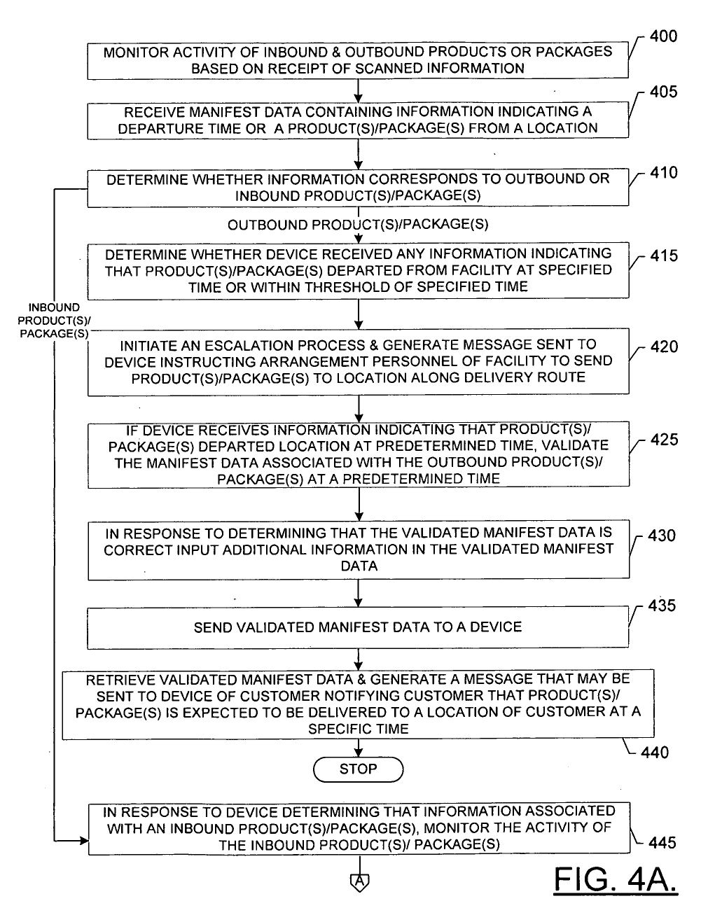

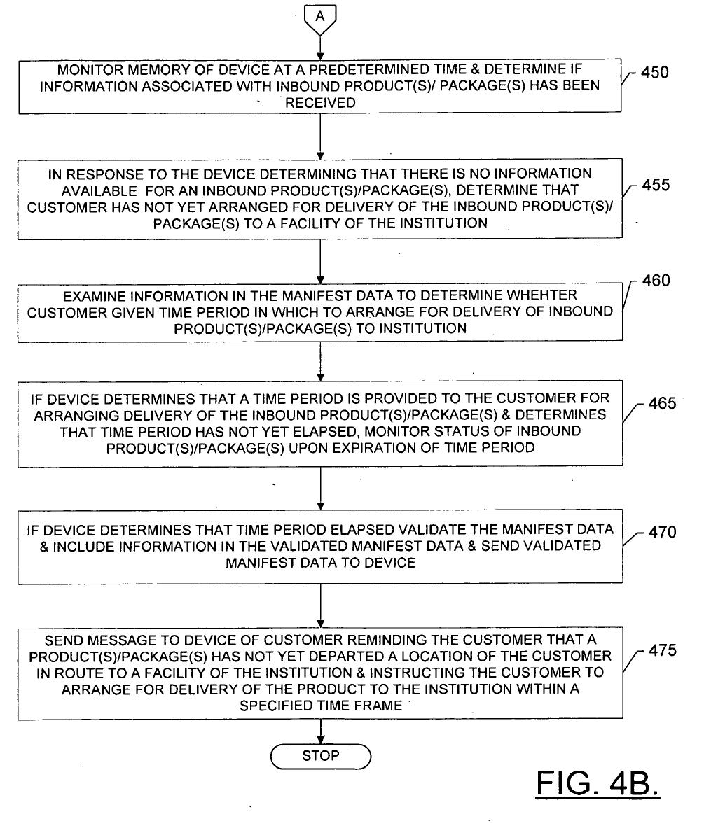

Referring now to FIGS. 4A and 4B, a flowchart for facilitating a customized return process according to an exemplary embodiment is provided. At operation 400, a processor of a device such as server 150 may monitor the activity of inbound and outbound products or packages based on information stored in a memory (e.g., data storage unit) in response to receipt of information associated with scanning of the tracking numbers corresponding to the inbound and outbound packages or products. The scanning may be performed by a scanning device such as for example DIAD 105. At operation 405, a device such as server 150 may receive manifest data sent from another device, such as for example a processor of electronic device 120 indicating a specific time (e.g., 12:00 AM) that one or more inbound and outbound products or packages are scheduled to depart a facility such as for example return center 8. At operation 410, a processor of a device such as server 150 may determine whether information (e.g., manifest data) associated with a product(s) corresponds to an outbound product(s) or package(s) or an inbound product(s) or package(s).

At operation 415, in response to the processor of the server 150 determining that the information associated with the product relates to an outbound product or package, the processor of the server 150 may determine whether server 150 received any information from the processor of the electronic device 120 indicating that the product or package departed a facility (e.g., return center) at the specified time or within a predetermined threshold (±5 min.) of the specified time. At operation 420, in response to the processor of the server 150 determining that it received a message from the processor of the electronic device indicating that the respective product or package did not depart from the facility, the processor of the server may initiate an escalation process and may generate a message that is sent to the processor of the electronic device instructing personnel of the facility to immediately arrange to send the outbound product or package to another location in its delivery route.

At operation 425, if the processor of the server 150 receives information from the processor of the electronic device 120 indicating that the product or package did in fact depart from the facility at the specified time, or within a predetermined threshold of the specified time, the processor of the server may immediately automatically validate the manifest data associated with the outbound product or package at a predetermined time (e.g., 4:00 AM each day of a year) in a manner analogous to that described above. At operation 430, in response to determining that the validated manifest data is correct, the processor of the server 150 may input additional information in the validated manifest data. This additional information may include, but is not limited to, information indicating an expected delivery time of a product or package (e.g., 10:30 AM) to a location of a customer. At operation 435, the processor of the server 150 may send the validated manifest data to a device such as for example electronic device 130 where the information may be stored. At operation 440, the processor of the electronic device 130 may retrieve the validated manifest data and generate a message that may be sent to a device (e.g., mobile or fixed phone 100, VoIP telephone 15, VoIP telephone 17) of a customer. The message may be a voice message notifying the customer that a product or package is expected to be delivered to a location of the customer at a given date and time in a manner analogous to that discussed above.

At operation 445, in response to the processor of the server 150 determining that the information associated with the product relates to an inbound product or package, the processor of the server 150 may monitor the activity of the inbound packages or products based on information stored in its memory (e.g., data storage unit) in response to receipt of information associated with scanning of the tracking numbers associated with the inbound packages or products. At least a portion of these inbound products or packages may be associated with (or assigned) a return service level. At operation 450, the processor of the server 150 may analyze and monitor a memory such as for example a data storage unit of the server 150, at a predetermined time (e.g., 4:30 AM each day of a year), and determine whether information associated with a scanned tracking number of an inbound product or package has been received by a scanning device such as for example DIAD 105.

At operation 455, if the processor of the server 150 determines that there is no information available for an inbound product(s) or package(s) as a result of a scan, the processor of the server may determine that that the customer has not yet arranged for delivery of the inbound product or package to a facility of the institution. At operation 460, the processor of the server 150 may examine information in the manifest data to determine whether the customer was given a time period in which to arrange for delivery of the inbound product or package to a facility of the institution. At operation 465, if the processor of the server determines that there was a time period provided to the customer for arranging delivery of the inbound product or package, but determines that the time period has not yet elapsed, the processor of the server 150 may monitor the status of the inbound product or package by examining its memory (e.g., data storage unit) upon expiration of the time period. At operation 470, if the processor of the server 150 determines that the time period has passed or elapsed, the processor of the server may validate the manifest data in a manner analogous to that discussed above and the processor of the server 150 may include information in the validated manifest data and the validated manifest data may be sent to an electronic device such as electronic device 130 of voice notification center 11. The information in the validated data may instruct the electronic device 130 to send a message to a device of the customer instructing the customer to arrange for delivery of the product(s) to be returned to a facility of the institution. At operation 475, the processor of the electronic device 130 may send a message to a device (e.g., mobile or fixed phone 100, VoIP telephone 15, VoIP telephone 17, etc.) of the customer. The message may contain information reminding the customer that a product has not yet departed a location of the customer in route to a facility (e.g., service center 2) of the institution and instructing the customer to arrange for delivery of the product to the facility of the institution within a specified time frame (e.g., 24 hrs, 48 hrs., etc.) As described above the message sent from the processor of the electronic device 130 to a device of the customer may be a voice message, text message or SMS message, email message, MMS message or any other suitable message.

It should be understood that each block or step of the flowchart, shown in FIGS. 4A and 4B and combination of blocks in the flowchart, can be implemented by various techniques, such as hardware, firmware, or software (e.g., return process code 87) in memory including one or more computer program instructions. For example, one or more of the procedures described above may be embodied by computer program instructions. In this regard, the computer program instructions which embody the procedures described above may be stored by a memory device of the electronic devices or server and executed by a built-in processor in the electronic devices or server. As will be appreciated, any such computer program instructions may be loaded onto a computer or other programmable apparatus (i.e., hardware) to produce a machine, such that the instructions which execute on the computer or other programmable apparatus (e.g., hardware) means for implementing the functions implemented specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the functions specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions that are carried out in the system.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for facilitating a customized return process for products, comprising:
periodically monitoring, via a processor, tracking information associated with one or more products;
determining, via the processor, whether at least one of the products corresponds to a first type of product among a plurality of types of products;
determining, via the processor at a first specified time, whether the at least one product has departed a first location of a first entity in route for delivery to a second entity in response to determining that the at least one product corresponds to the first type;
determining, via the processor, whether the first entity was given a first predetermined time period in which the at least one product was scheduled to depart the first location of the first entity in route for delivery to the second entity,
wherein in response to the determination revealing that the first entity was given the first predetermined time period, determining whether the at least one product departed the first location of the first entity upon expiration of the predetermined time period; and
sending, via the processor, a first message to the first entity in response to the determination revealing that the at least one product did not depart from the first location upon the expiration of the predetermined time period, the first message comprises data instructing the first entity to send the product to the second entity within a second predetermined time period.

2. The method of claim 1, wherein sending comprises sending the first message via a telephone call to a first device of the first entity, wherein the data comprises voice data comprising one or more speech signals corresponding to a voice recording.

3. The method of claim 1, wherein the data of the first message comprises information indicating a monetary fee that is owed by the first entity due to failure of the least one product departing from the first location within the first predetermined time period.

4. The method of claim 1, wherein the data of the first message comprises information requesting whether the first entity would like to arrange for pickup of the at least one product to be delivered to the second entity by a shipping carrier.

5. The method of claim 1, further comprising:
determining, via the processor, whether at least one other of the products corresponds to a second type of package among a plurality of types of packages;
determining, via the processor at a second specified time, whether the at least one other product was scheduled to depart a second location of a third entity at a certain time; and
determining, via the processor, whether the at least one product departed the second location within a threshold of the certain time.

6. The method of claim 5, wherein the first entity comprises a purchaser of the at least one product or an entity that otherwise obtained the at least one product and the second entity comprises a seller or manufacturer of the at least one product and wherein the first type of product comprises a product that is to be returned to the second entity by the first entity and the second type of product is a product that is to be sent to the first entity by second entity.

7. The method of claim 5, further comprising:
generating, via the processor, a second message in response to the determination revealing that the at least one product did not depart the second location within the threshold; and
sending, via the processor, the second message to the third entity, the message comprises information instructing the third entity to immediately send the at least one other product to another location.

8. The method of claim 7, further comprising:
generating, via the processor, a third message and sending the third message to the first entity, the third message comprises content indicating a time and date that the at least other product is expected to be delivered to the first entity and includes information specifying that the other product will be delivered to the first location associated with the first entity.

9. The method of claim 5, further comprising:
associating, via the processor, at least a first tracking number corresponding to the at least one product with at least a second tracking number corresponding to the at least other product; and
generating data associated with the at least one product and the at least one other product when at least one of the first or second tracking numbers are scanned.

10. An apparatus for facilitating a customized return process, the apparatus comprising a processor configured to:
periodically monitor tracking information associated with one or more products;
determine whether at least one of the products corresponds to a first type of product among a plurality of types of products;
determine, at a first specified time, whether the at least one product has departed a first location of a first entity in route for delivery to a second entity, in response to determining that the at least one product corresponds to the first type;
determine whether the first entity was given a first predetermined time period in which the at least one product was scheduled to depart the first location of the first entity in route for delivery to the second entity,
wherein in response to the determination revealing that the first entity was given the first predetermined time period, determine whether the at least one product departed the first location of the first entity upon expiration of the predetermined time period; and
send a first message to a first device which is configured to transmit the first message to the first entity in response to the determination revealing that the at least one product did not depart from the first location upon the expiration of the predetermined time period, the first message comprises data instructing the first entity to send the product to the second entity within a second predetermined time period.

11. The apparatus of claim 10, wherein the processor the processor is configured to send the first message via a telephone call to a second device of the first entity, wherein the data comprises voice data comprising one or more speech signals corresponding to a voice recording.

12. The apparatus of claim 10, wherein the data of the first message comprises information indicating a monetary fee that is owed by the first entity due to failure of the least one product departing from the first location within the first predetermined time period.

13. The apparatus of claim 10, wherein the data of the first message comprises information requesting whether the first entity would like to arrange for pickup of the at least one product to be delivered to the second entity a shipping carrier.

14. The apparatus of claim 10, wherein the processor is further configured to:
determine whether at least one other of the products corresponds to a second type of package among a plurality of types of packages;
determine, at a second specified time, whether the at least one other product was scheduled to depart a second location of a third entity at a certain time; and
determine whether the at least one product departed the second location within a threshold of the certain time.

15. The apparatus of claim 14, wherein the first entity comprises a purchaser of the at least one product or an entity that otherwise obtained the at least one product and the second entity comprises a seller or manufacturer of the at least one product and wherein the first type of product comprises a product that is to be returned to the second entity by the first entity and the second type of product is a product that is to be sent to the first entity by second entity.

16. The apparatus of claim 14, wherein the processor is further configured to:
generate a second message in response to the determination revealing that the at least one product did not depart the second location within the threshold; and
send the second message to the third entity, the message comprises information instructing the third entity to immediately send the at least one other product to another location.

17. The apparatus of claim 16, wherein the processor is further configured to:
generate a third message and send the third message to the first device which transmits the third message to the first entity, the third message comprises content indicating a time and date that the at least other product is expected to be delivered to the first entity and includes information specifying that the other product will be delivered to the first location associated with the first entity.

18. The apparatus of claim 14, wherein the processor is further configured to:
associate at least a first tracking number corresponding to the at least one product with at least a second tracking number corresponding to the at least one other product; and
generate data associated with the at least one product and the at least one other product when at least one of the first or second tracking numbers are scanned.

19. A computer program product for facilitating a customized return process, the computer program product comprising at least one computer-readable storage medium having computer-readable program code portions stored therein, the computer-readable program code portions comprising:
a first executable portion for periodically monitoring tracking information associated with one or more products;
a second executable portion for determining whether at least one of the products corresponds to a first type of product among a plurality of types of products;
a third executable portion for determining, at a first specified time, whether the at least one product has departed a first location of a first entity in route for delivery to a second entity in response to determining that the at least one product corresponds to the first type;
a fourth executable portion for determining whether the first entity was given a first predetermined time period in which the at least one product was scheduled to depart the first location of the first entity in route for delivery to the second entity,
wherein in response to the determination revealing that the first entity was given the first predetermined time period, determining whether the at least one product departed the first location of the first entity upon expiration of the predetermined time period; and
a fifth executable portion for sending a first message to the first entity in response to the determination revealing that the at least one product did not depart from the first location upon the expiration of the predetermined time period, the first message comprises data instructing the first entity to send the product to the second entity within a second predetermined time period.

20. The computer program product of claim 19, further comprising:
a sixth executable portion for determining whether at least one other of the products corresponds to a second type of package among a plurality of types of packages;
a seventh executable portion for determining, at a second specified time, whether the at least one other product was scheduled to depart a second location of a third entity at a certain time; and
an eighth executable portion for determining whether the at least one product departed the second location within a threshold of the certain time.
